(19) United States
(12) Patent Application Publication
(10) Pub. No.: US 2026/0331600 A1
(43) Pub. Date: Oct. 22, 2026

(54) ELECTROLYTE FOR A LITHIUM METAL BATTERY, AND A LITHIUM METAL BATTERY INCLUDING THE SAME

(71) Applicants: HYUNDAI MOTOR COMPANY, Seoul (KR); KIA CORPORATION, Seoul (KR)

(72) Inventors: Kyuju Kwak, Hwaseong-si (KR); Ji Yong Lee, Hwaseong-si (KR); Sangheon Lee, Hwaseong-si (KR); Eunji Kwon, Hwaseong-si (KR); Yeonjong Oh, Hwaseong-si (KR); Jiho Lim, Hwaseong-si (KR); Dong Hyun Lee, Hwaseong-si (KR); Sangsu Lee, Hwaseong-si (KR); Kyoung Han Ryu, Hwaseong-si (KR); Samuel Seo, Hwaseong-si (KR)

(73) Assignees: HYUNDAI MOTOR COMPANY, Seoul (KR); KIA CORPORATION, Seoul (KR)

(21) Appl. No.: 19/412,075

(22) Filed: Dec. 8, 2025

(30) Foreign Application Priority Data
Apr. 9, 2025 (KR) 10-2025-0045986

(51) Int. Cl. H01M 10/42; H01M 10/052; H01M 10/0568; H01M 10/0569

(52) U.S. Cl. CPC H01M 10/4235; H01M 10/052; H01M 10/0568; H01M 10/0569; H01M 2300/0037

(57) ABSTRACT

An electrolyte for a lithium metal battery includes a lithium salt, and a non-aqueous organic solvent. The non-aqueous organic solvent includes a main solvent and a co-solvent. The main solvent includes N,N-dimethylsulfamoyl fluoride, ethylene carbonate, diethyl carbonate, dimethyl carbonate, ethylmethyl carbonate, 1,2-dimethoxyether, dipropyl ether, cyclic sulfonamide, or any combination thereof. The co-solvent is represented by Chemical Formula 1, and the co-solvent is included in an amount exceeding 1 mol % based on a total amount (100 mol %) of the non-aqueous organic solvent.

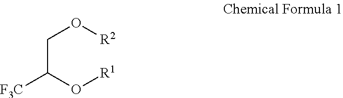

In Chemical Formula 1, each substituent is the same as defined in the detailed description.

### CROSS-REFERENCE TO RELATED APPLICATION

This application claims priority to and the benefit of Korean Patent Application No. 10-2025-0045986 filed with the Korean Intellectual Property Office on Apr. 9, 2025, the entire contents of which are incorporated herein by reference.

### TECHNICAL FIELD

The present disclosure relates to an electrolyte for a lithium metal battery and a lithium metal battery including the same.

### BACKGROUND

As the electric vehicle market grows, there is an increasing need for high-capacity batteries that surpass lithium ion batteries and accordingly, an increasing demand for negative and positive electrode materials with high energy density and long-term stability of the lithium metal batteries.

Lithium metal, which has high capacity per weight of 3,860 mAh/g and a low standard electrode potential (−3.04 V vs normal hydrogen electrode), is attracting attentions as a negative electrode material for rechargeable lithium batteries. However, the lithium metal is highly reactive, creating an extremely reducing atmosphere during the charging process, which may cause an irreversible decomposition reaction between the lithium metal and an electrolyte. The decomposition reaction may deplete the electrolyte, wherein the decomposition products may form a nonuniform film on the lithium metal surface. In addition, the lithium grows in the form of dendrites, as charging and discharging are repeated. The dendritic lithium causes electrical short circuits inside the batteries, leading to safety issues such as fires of the batteries and the like.

Therefore, in order to apply lithium metal with high stability and high capacity, it is desired to develop an electrolyte that alleviates reactivity of lithium metal, prevents dendritic lithium growth, and enables uniform lithium electrodeposition (plating).

The statements in this Background section merely provide background information related to the present disclosure and may not constitute prior art.

### SUMMARY

An embodiment of the present disclosure provides an electrolyte for a lithium metal battery that can contribute to improving durability of a lithium metal battery by delaying the decomposition of an anion constituting a lithium salt, and at the same time, can reduce the phenomenon of continuous consumption of a lithium salt for forming a film by reaction with lithium metal because the electrolyte is stable to lithium metal and reaction is limited.

In addition, an embodiment provides a lithium metal battery having excellent stability.

According to an embodiment, an electrolyte for a lithium metal battery includes a lithium salt and a non-aqueous organic solvent. The non-aqueous organic solvent includes a main solvent and a co-solvent. The main solvent includes N,N-dimethylsulfamoyl fluoride, ethylene carbonate, diethyl carbonate, dimethyl carbonate, ethylmethyl carbonate, 1,2-dimethoxyether, dipropyl ether, cyclic sulfonamide, or any combination thereof. The co-solvent is represented by Chemical Formula 1:

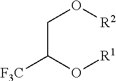

in Chemical Formula 1, R¹ is a substituted or unsubstituted C2 to C20 alkyl group, and R² is a substituted or unsubstituted C1 to C20 alkyl group. R¹ and R² are different from each other, and R¹ has more carbon atoms than R². The co-solvent is included in an amount exceeding 1 mol % based on a total amount (100 mol %) of the non-aqueous organic solvent.

The main solvent may includes N,N-dimethylsulfamoyl fluoride.

The co-solvent may be a compound in Chemical Formula 1, wherein R¹ is an ethyl group and R² is a methyl group.

The co-solvent may be included in an amount of 2.5 mol % or more, based on a total amount (100 mol %) of the non-aqueous organic solvent.

The co-solvent may be included in an amount in a range of 2.5 mol % to 10 mol %, based on a total amount (100 mol %) of the non-aqueous organic solvent.

The lithium salt and non-aqueous organic solvent may have a molar ratio in a range of 1:1 to 1:5.

The lithium salt may include at least one of lithium bis(fluorosulfonyl)imide (LiFSI), lithium (fluorosulfonyl)(nonafluorobutanesulfonyl)imide (LiFNFSI), lithium bis(trifluoromethanesulfonyl)imide (LiTFSI), or any combination thereof.

A concentration of the lithium salt may be in a range of 1.0 M to 5.0 M.

A lithium nuclear magnetic resonace (Li-NMR) signal value of the electrolyte for the lithium metal battery may have a more positive value than a Li-NMR signal value of an electrolyte for a lithium metal battery that does not include the co-solvent.

According to another embodiment, a lithium metal battery may include a positive electrode; a lithium metal layer as a negative electrode facing the positive electrode; a separator between the positive electrode and the negative electrode; and the electrolyte for the lithium metal battery.

The lithium metal layer may have a thickness in a range of 5 μm to 50 μm.

According to another embodiment, a lithium metal battery may include a first electrode; a lithium metal layer as a second electrode facing the first electrode; a separator between the first electrode and the second electrode; and the electrolyte for the lithium metal battery.

The electrolyte for the lithium metal battery according to an embodiment forms a suitable solvation environment to enhance inhibition of oxidative decomposition of salts, thereby delaying further depletion of salts, and by introducing a compound as a co-solvent that has lower reactivity toward a lithium negative electrode than a main solvent and may thus exhibit a sustained effect, a lithium metal battery including the electrolyte may have improved durability performance and excellent stability.

### BRIEF DESCRIPTION OF THE DRAWINGS

FIG. 1 is a view illustrating whether the oxidative decomposition and reductive decomposition of a salt are delayed or accelerated depending on what type of co-solvent is used together with the main solvent that creates a weak solvation environment.

FIG. 2 shows the results of durability evaluation of lithium metal battery cells using each electrolyte according to Example 1 and Comparative Example 1.

FIG. 3 shows the results of nuclear magnetic resonance (NMR) quantitative analysis of the electrolyte according to Comparative Example 1.

FIG. 4 shows the results of NMR quantitative analysis of the electrolyte according to Example 1.

FIG. 5 shows the lithium nuclear magnetic resonance (Li-NMR) analysis results of the electrolytes according to Example 1, Comparative Example 1, and Comparative Example 4.

FIG. 6 shows the results of durability evaluation of lithium metal battery cells using each electrolyte according to Examples 1 to 4 and Comparative Example 1.

FIG. 7 shows the results of durability evaluation of lithium metal battery cells using each electrolyte according to Comparative Examples 1 and 2.

FIG. 8 shows the results of durability evaluation of lithium metal battery cells using each electrolyte according to Comparative Examples 1, 3, and 4.

FIG. 9 shows the results of NMR quantitative analysis of the electrolyte according to Comparative Example 3.

FIG. 10 shows the results of NMR quantitative analysis of the electrolyte according to Comparative Example 4.

FIG. 11 shows the results of durability evaluation of lithium metal battery cells using each electrolyte according to Comparative Examples 1 and 5.

FIG. 12 is a schematic diagram of an embodiment of a lithium metal battery.

The drawings described herein are for illustration purposes only and are not intended to limit the scope of the present disclosure in any way.

### DETAILED DESCRIPTION

In the present specification, terms including first, second, and third are used for describing various arts, components, regions, layers, and/or sections, but are not limited thereto. The terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present disclosure.

Special terms used herein is for the purpose of describing specific embodiments only and are not intended to be limiting of the present disclosure. The singular forms used herein include plural forms as well, if the phrases do not clearly have the opposite meaning. The term “including” or “comprising” used in the specification means that a specific feature, region, integer, step, operation, element and/or component is embodied and other specific features, regions, integers, steps, operations, elements, and/or components are not excluded.

When any part of or referred to as being “on”, “over” the other part, which might be directly on or over the other parts or may be a different part involves therebetween. On the contrary, when any part is mentioned as being “directly on” the other parts, the other part is not interposed therebetween.

Unless defined otherwise, all terms including technical and scientific terms used herein have the same meaning as commonly understood by those having ordinary skill in the art to which the present disclosure belongs. Commonly used predefined terms are further interpreted as having a meaning consistent with the relevant technical literature and the present disclosure, and are not to be construed as ideal or very formal meanings unless defined otherwise.

As used herein, the term “combination(s) thereof” described in the expression refers to one or more mixtures or combinations selected from the components described in the expression, and refers to including at least one selected from the components. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, the present disclosure are described more fully, in which example embodiments of the present disclosure are shown. As those having ordinary skill in the art would realize, the described embodiments may be modified in various different ways, all without departing from the spirit or scope of the present disclosure.

### <Electrolyte for Lithium Metal Battery>

Active development is underway on the composition of electrolytes (salt type, salt concentration, additives, and the like) to improve the durability of lithium metal batteries. The present disclosure relates to a technology capable of improving durability characteristics by introducing a new type of co-solvent to control the composition of the solvent and thus to delay the decomposition of salts and solvents in an electrolyte.

According to an embodiment, a non-aqueous organic solvent in an electrolyte for a lithium metal battery is composed of a main solvent and a co-solvent. At this time, by including a co-solvent whose type and amount are controlled in the electrolyte, i) local overconcentration is implemented to delay the decomposition of a salt or solvent, and ii) at the same time, physical properties such as wettability and volatility are improved to reduce overvoltage.

Commonly used co-solvents may include a weak solvating solvent, mainly perfluorinated ether solvents with a wide voltage range, and representative examples thereof may include TTE (1,1,2,2-tetrafluoroethyl-2,2,3,3-tetrafluoropropyl ether), BTFE (bis(2,2,2-trifluoroethyl) ether), and TFOFE (trifluoromethyl trifluorovinyl ether).

According to an embodiment, the main solvent in the non-aqueous organic solvent may include N,N-dimethylsulfamoyl fluoride, ethylene carbonate, diethyl carbonate, dimethyl carbonate, ethylmethyl carbonate, 1,2-dimethoxyether, dipropyl ether, cyclic sulfonamide, or any combination thereof. Among these, the electrolyte for lithium metal batteries including N,N-dimethylsulfamoyl fluoride as a solvent is suffering from continuous salt deterioration, which is the main cause of deterioration in the durability of the battery. In particular, the easy oxidation environment of anions is an essential task that should be addressed in high-voltage batteries.

Accordingly, various additives are being developed to delay the above-mentioned deterioration, but there is a problem that the instability of the protective film causes continuous consumption of the additives and increases electrode resistance, thereby hindering output characteristics. Therefore, there has been an attempt to induce agglomeration of salt-solvent and suppress decomposition of salt and solvent by applying a perfluorinated ether-based co-solvent, but rather, the agglomeration phenomenon increases negative electrode reactivity of lithium salt, accelerating reductive decomposition. It has been confirmed that the agglomeration phenomenon is difficult to maintain in a high-temperature environment formed by the exothermic reaction occurring in battery discharge, but there is continuous consumption of lithium salt that reacts with lithium metal to form a film, making it difficult to adopt it as a commercialization strategy.

Therefore, the need for the development of a co-solvent that suppresses the reductive decomposition of salts and has a lasting effect is growing in the lithium metal battery field.

According to an embodiment, by adding a co-solvent represented by Chemical Formula 1 to a main solvent including N,N-dimethylsulfamoyl fluoride (DMSF), ethylene carbonate, diethyl carbonate, dimethyl carbonate, ethylmethyl carbonate, 1,2-dimethoxyether, dipropyl ether, cyclic sulfonamide or any combination thereof in an amount exceeding 1 mol % based on the total amount (100 mol %) of a non-aqueous organic solvent including the main solvent and the co-solvent, the decomposition of the bis(fluorosulfonyl)imide (FSI) anion, which is an anion of a lithium salt, may be delayed, thereby contributing to improving the durability of a lithium metal battery, and providing an electrolyte for a lithium metal battery which is stable to lithium metal and thus limits the reaction, and thus has greatly improved stability.

Chemical Formula 1:

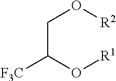

In Chemical Formula 1,
R¹ is a substituted or unsubstituted C2 to C20 alkyl group, and
R² is a substituted or unsubstituted C1 to C20 alkyl group,
provided that, R¹ and R² are different from each other, and R¹ has more carbon atoms than R².

The electrolyte for the lithium metal battery according to an embodiment may include a lithium salt and a non-aqueous organic solvent. The non-aqueous organic solvent includes a main solvent and a co-solvent, wherein the main solvent may include N,N-dimethylsulfamoyl fluoride (DMSF), ethylene carbonate, diethyl carbonate, dimethyl carbonate, ethylmethyl carbonate, 1,2-dimethoxyether, dipropyl ether, cyclic sulfonamide or any combination thereof, and the co-solvent may include the compound represented by Chemical Formula 1. The co-solvent represented by Chemical Formula 1 should be included in an amount exceeding 1 mol % based on a total amount (100 mol %) of the non-aqueous organic solvent. The co-solvent including the compound represented by Chemical Formula 1 should be included in the above amount to help improve the performance of the lithium metal battery. However, if the co-solvent including the compound represented by Chemical Formula 1 is included in an amount of 1 mol % or less based on a total amount (100 mol %) of the non-aqueous organic solvent, the durability performance of the lithium metal battery may be reduced, which may be undesirable.

When the compound represented by Chemical Formula 1 is used as a co-solvent together with the main solvent in the above amount range, it is stable to lithium metal, and thus, it is possible to manufacture a highly stable electrolyte.

For example, the main solvent may be N,N-dimethylsulfamoyl fluoride (DMSF), and the co-solvent may be a compound in which R¹ is an ethyl group and R² is a methyl group in Chemical Formula 1, i.e., 2-ethoxy-1,1,1-trifluoro-3-methoxypropane (TFEMP).

The present disclosure is capable of differentiating the composition from the prior art in that it proposes a co-solvent that i) further delays salt depletion by strengthening the inhibition of salt reductive decomposition, and ii) has lower reactivity toward a lithium negative electrode than the main solvent, DMSF solvent, and thus can exhibit a sustained effect. Through this, it is expected that durability may be improved by delaying salt depletion without inhibiting the effect of the solvent participating in the formation of a conventional negative electrode film.

The compound represented by Chemical Formula 1 i) has a lower degree of salt dissociation than the main solvent DMSF, thereby forming an optimal solvation environment and suppressing reductive decomposition of the salt, and ii) has a lowest unoccupied molecular orbital (LUMO) energy level higher than the energy level of the main solvent DMSF, thereby being able to exert a sustained effect, and ultimately, it is possible to confirm an improvement in durability when operating a lithium metal battery including an electrolyte having a composition according to an embodiment.

The co-solvent may be included in an amount of 2.5 mol % or more, for example, 2.5 mol % to 10 mol %, based on a total amount (100 mol %) of the non-aqueous organic solvent.

The lithium salt and the non-aqueous organic solvent of the above composition may have a molar ratio of 1:1 to 1:5.

When the type and amount of the co-solvent (and additionally the molar ratio of the lithium salt and non-aqueous organic solvent) are controlled as described above, it is possible to prepare an electrolyte with extremely improved durability and stability while delaying the decomposition of the lithium salt due to oxidation and reduction.

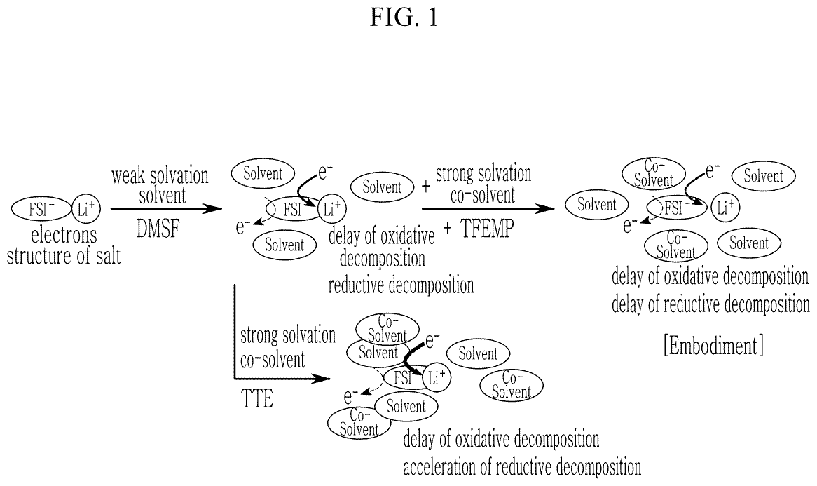

When the N,N-dimethylsulfamoyl fluoride (DMSF), which is a solvent participating in the formation of a negative electrode film, is used alone as a non-aqueous organic solvent, i.e., when the co-solvent is not included, unlike an embodiment, the low electrochemical reduction stability of the salt derived from the use of a weakly solvating solvent causes salt reductive decomposition at the negative electrode to be observed, thereby reducing the film-forming effect of N,N-dimethylsulfamoyl fluoride and accelerating deterioration due to a decrease in salt concentration, making it inevitable that a strategy for improving durability is required. When the compound represented by Chemical Formula 1 is introduced as a co-solvent, it becomes possible to suppress the decomposition of salt and introduce an absolute excess of salt. (See FIG. 1, and the like)

When the compound represented by Chemical Formula 1 used as a co-solvent is used alone as a main solvent, i.e., when the compound represented by Chemical Formula 1 alone is used as a non-aqueous organic solvent, it has a stronger solvation structure than an electrolyte using an existing ether solvent alone, and due to the lower electrochemical oxidation stability of the salt derived from the stronger solvation structure than the above N,N-dimethylsulfamoyl fluoride, salt oxidative decomposition at the anode is observed, and an increase in positive electrode resistance and salt depletion due to the formation of a positive electrode film are bound to occur. To solve this problem, it is necessary to induce inhibition of salt decomposition and input an absolute excess of salt, and this problem may be solved through the composition of the electrolyte according to an embodiment.

A non-aqueous organic solvent is also prepared by using 1,2-dimethoxyethane (DME), which is commonly used as an ether-based solvent, as the main solvent, and 1,1,2,2-tetrafluoroethyl-2,2,3,3-tetrafluoropropyl ether (TTE), which is a commonly used co-solvent mentioned above. In this case, there is an advantage in that it causes structural agglomeration in the electrolyte, delays the oxidative decomposition of the electrolyte, and improves the limitations of ionic conductivity and viscosity. However, this composition is intended to mimic the weak solvating solvent environment and has the problem that 1) the salt concentration is reduced by reductive decomposition of the salt, and 2) the salt is precipitated with a low salt dissociation degree when excessively added to find the optimal solvation environment, making it difficult to control the salt amount. In addition, the film-forming effect of the solvent including N,N-dimethylsulfamoyl fluoride (DMSF) alone deteriorates due to the chemical reaction at the negative electrode caused by the low LUMO energy level of the co-solvent, and it is difficult to observe continuous performance improvement.

In contrast, according to an embodiment, 1) an electrolyte composition is proposed that increases the amount of salts with delayed decomposition, and 2) has low reactivity toward a lithium negative electrode and thus exhibits a continuous effect. This is expected to improve durability by delaying salt depletion without inhibiting the effect of a solvent participating in the formation of a negative electrode film of an electrolyte composition including N,N-dimethylsulfamoyl fluoride (DMSF) alone.

In other words, when the main solvent includes N,N-dimethylsulfamoyl fluoride (DMSF), the co-solvent represented by Chemical Formula 1 should 1) form an optimal solvation environment to suppress oxidative/reductive decomposition of the salt, 2) have excellent salt solubility so that they may be mixed into the solvent to dissociate excess salt, and 3) be stable to lithium metal. Therefore, it may be most advantageous to use 2-ethoxy-1,1,1-trifluoro-3-methoxypropane (TFEMP) as the co-solvent.

By using an electrolyte having a composition according to an embodiment, it is possible to improve the durability of a lithium metal battery using the electrolyte.

According to an embodiment, the lithium salt may include at least one lithium bis(fluorosulfonyl)imide (LiFSI), lithium (fluorosulfonyl)(nonafluorobutanesulfonyl)imide (LiFNFSI), lithium bis(perfluoroethylsulfonyl)imide (LiBETI), lithium bis(trifluoromethanesulfonyl)imide (LiTFSI), or any combination thereof. For example, the lithium salt may be LiFSI.

A concentration of the lithium salt included in the electrolyte for the lithium metal battery according to an embodiment may be 1.0 M to 5.0 M, specifically 1.0 M to 4.0 M.

If the concentration of the lithium salt is below the above range, the conductivity of the electrolyte may decrease, which may result in poor electrolyte performance, and if the concentration of the lithium salt exceeds the above range, the viscosity of the electrolyte may increase, which may result in reduced mobility of lithium ions and a problem of overvoltage occurring from the beginning of the cycle. In addition, it is undesirable that the SEI layer formed on the surface of the lithium metal, which is the negative electrode, is not formed at all or that a film that is too thick is formed, which may lower the electrochemical performance of the lithium metal battery.

Since the electrolyte for a lithium metal battery according to an embodiment is closer to a strong solvation environment than a conventionally used weak solvating solvent, the lithium nuclear magnetic resonace (Li-NMR) signal value of the electrolyte for a lithium metal battery according to an embodiment may have a more positive value than the Li-NMR signal value of the electrolyte for a lithium metal battery that does not include the co-solvent (and the electrolyte for a lithium metal battery that includes a compound not represented by Chemical Formula 1 as a co-solvent).

### <Lithium Metal Battery>

Another embodiment provides a lithium metal battery including the electrolyte for the aforementioned lithium metal battery.

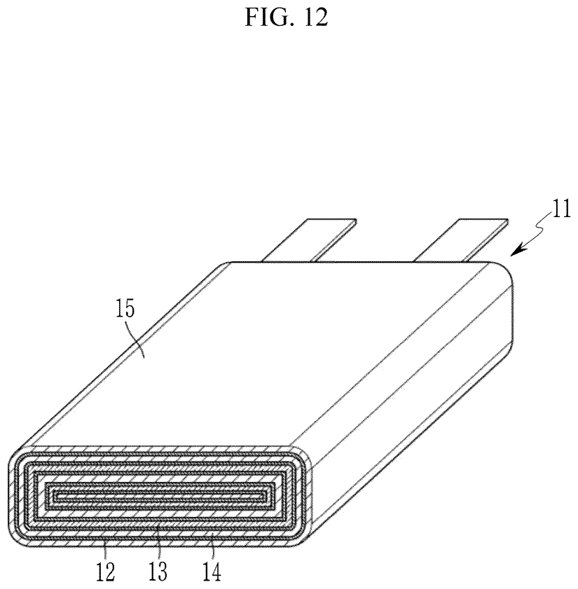

Specifically, the lithium metal battery (11) may include a positive electrode (13), a lithium metal layer (12) as a negative electrode facing the positive electrode, a separator (14) between the positive electrode (13), and the negative electrode (12) and the electrolyte for the lithium metal battery. (referring FIG. 12)

The negative electrode for a lithium metal battery may be a lithium metal layer, and the lithium metal layer itself may be used as a negative electrode for a battery.

A battery including the negative electrode may allow lithium ions from the positive electrode to move to the negative electrode to form a lithium metal layer when charged. Charging and discharging of the battery may be proceeded by forming or removing this lithium metal layer.

The negative electrode may be formed on a negative current collector such as copper.

The lithium metal layer may be formed on the negative current collector by the formation charging and discharging of the lithium metal battery.

The lithium metal layer may have a thickness of 5 μm to 50 μm, for example, 10 μm to 50 μm or may be formed to have the above thickness.

When the lithium metal layer satisfies the above thickness, side reactions between the lithium metal layer and the electrolyte may be suppressed, thereby improving the electrochemical performance of the lithium metal battery.

In another embodiment, the positive electrode is disposed opposite the negative electrode.

The positive electrode may include a positive electrode current collector and a positive electrode active material layer formed on the positive electrode current collector.

The positive electrode current collector may be made of at least one of stainless steel, aluminum, nickel, titanium, calcined carbon, or aluminum or stainless steel surface-treated with carbon, nickel, titanium, silver, any combination thereof, or the like.

A thickness of the positive electrode current collector may be 3 μm to 500 μm.

The positive electrode active material layer includes a positive electrode active material.

The positive electrode active material may be a compound capable of reversibly intercalating and deintercalating lithium, and specifically may include lithium iron phosphate. When the positive electrode active material includes lithium iron phosphate, the compatibility with the aforementioned electrolyte is the best, so that the effect of improving battery performance may be maximized.

The positive electrode active material may include a lithium metal oxide, which is a compound capable of intercalating and deintercalating lithium, and specifically includes at least one selected from cobalt, manganese, nickel, and aluminum. More specifically, the lithium metal oxide may include at least one selected from a lithium-manganese-based oxide, a lithium-cobalt-based oxide, a lithium-nickel-based oxide, a lithium-nickel-manganese-based oxide, a lithium-nickel-cobalt-based oxide, a lithium-manganese-cobalt-based oxide, a lithium-nickel-manganese-cobalt-based oxide, or a lithium-nickel-cobalt-transition metal (M) oxide.

The positive electrode active material may be a lithium-nickel-manganese-cobalt-based oxide that can specifically improve the capacity characteristics and stability of the battery, and may be more specifically represented by Chemical Formula 2:

Li(NiₓCo_{y}Mn_{z})O₂

In Chemical Formula 2,
0≤x≤1, 0≤y≤1,0≤z≤1, and x+y+z=1.

The positive electrode active material layer may further include a binder and/or a conductive material.

The separator separates the negative electrode and the positive electrode and provides a passage for lithium ions to move, and is not particularly limited as long as it is a separator commonly used in rechargeable lithium batteries.

The following examples illustrate the present disclosure in more detail. However, the following examples are only example embodiments, and the present disclosure is not limited to the following examples.

### (Example) Preparation of Electrolyte for Lithium Metal Battery

LiFSI salt was added to a non-aqueous organic solvent to dissociate and form an electrolyte, then calcium hydride (CaH₂) of 1% or more of the total weight of the sample is added and removed after 30 minutes to finally prepare an electrolyte for a lithium metal battery.

Table 1 shows the composition of electrolytes for lithium metal battery cells according to Examples and Comparative Examples.

TABLE 1

| | | | Co-solvent (mol % based |
|---|---|---|---|
| | | | on a total amount of non- |
| | Salt | Main solvent | aqueous organic solvent) |
| Example 1 | LiFSI | N,N-dimethylsulfamoyl | 2-Ethoxy-1.1.1-trifluoro-3- |
| | | fluoride (DMSF) | methoxypropane |
| | | | (TFEMP) (5.0) |
| Example 2 | LiFSI | N,N-dimethylsulfamoyl | 2-Ethoxy-1.1.1-trifluoro-3- |
| | | fluoride (DMSF) | methoxypropane |
| | | | (TFEMP) (2.5) |
| Example 3 | LiFSI | N,N-dimethylsulfamoyl | 2-Ethoxy-1.1.1-trifluoro-3- |
| | | fluoride (DMSF) | methoxypropane |
| | | | (TFEMP) (7.5) |
| Example 4 | LiFSI | N,N-dimethylsulfamoyl | 2-Ethoxy-1.1.1-trifluoro-3- |
| | | fluoride (DMSF) | methoxypropane |
| | | | (TFEMP) (10.0) |
| Com- | LiFSI | N,N-dimethylsulfamoyl | — |
| parative | | fluoride (DMSF) | |
| Example 1 | | | |
| Com- | LiFSI | N,N-dimethylsulfamoyl | 2-Ethoxy-1.1.1-trifluoro-3- |
| parative | | fluoride (DMSF) | methoxypropane |
| Example 2 | | | (TFEMP) (1.0) |
| Com- | LiFSI | N.N-dimethylsulfamoyl | 1,2-dimethoxypropane |
| parative | | fluoride (DMSF) | (DMP) (5.0) |
| Example 3 | | | |
| Com- | LiFSI | N,N-dimethylsulfamoyl | 1,1.1-trifluoro- |
| parative | | fluoride (DMSF) | 2,3-dimethoxypropane |
| Example 4 | | | (TFDMP) (5.0) |
| Com- | LiFSI | N,N-dimethylsulfamoyl | 2-Methoxy-1.1.1- |
| parative | | fluoride (DMSF) | trifluoro-3-ethoxypropane |
| Example 5 | | | (TFMEP) (5.0) |

### Performance Verification of Lithium Metal Battery Cell Using Electrolyte Including Co-Solvent Controlling Solvation Environment-1

(1) After manufacturing coin cells with the composition shown in Table 2, durability thereof was confirmed.

TABLE 2

| | | | | | |
|---|---|---|---|---|---|
| Positive | 4.0 mAh/cm² | / | 20 μm Li on Cu | / | SIO922A7 |
| electrode/negative | | | | | |
| electrode/coating | | | | | |
| separator | | | | | |
| Injection amount | 1.5 mL | / | 2.10 g/Ah | | |
| Voltage range | 3.0-4.25 | | 1/3C-1/3C | / | 25 °C |
| (V)/C- | | | | | |
| rate/evaluation | | | | | |
| temperature | | | | | |
| Jig/surface | Balanced | | 10 kgf/cm² | | |
| pressure | pressure | | | | |
| | distribution | | | | |

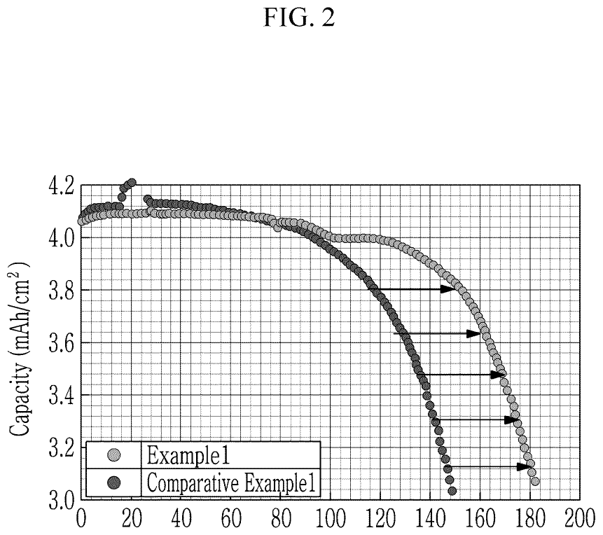

(2) It can be confirmed that Example 1 was an electrolyte with the highest durability observed, was an electrolyte with a TFEMP amount of 5.0 mol %, and exhibited a 23% cycle-life deterioration delay effect compared to Comparative Example 1 (143 times) that did not include a co-solvent, with a Li/NMC durability of 177 times. (See FIG. 2)
(3) Fluorine nuclear magnetic resonance (F-NMR) analysis was performed to confirm the deterioration factor in the electrolyte, and the results are shown in Table 3. Specifically, after 2.5 g/Ah of electrolyte was injected into a 0.169 Ah bicell, samples were collected after 50 and 100 charge/discharge cycles under the evaluation conditions shown in FIG. 2, and F-NMR measurements were performed. For sampling, the upper portion of the pouch cell was cut, 1 mL of DME was injected to wash away the residual electrolyte, and 900 μl of a mixed solution of 30 g of d⁶-dimethyl sulfoxide (DMSO) as an nuclear magnetic resonance (NMR) solvent and 5 g of fluorobenzene as an internal standard solution was injected into the aliquoted sample solution, and F-NMR measurement was performed (500 MHz, Unity Inova, Varian Technology). From the F-NMR measurement results, the areas of DMSF, FSI, and fluorobenzene signals were read, and from these, DMSF/FSI (mol) and FSI/fluorobenzene (mol) were calculated, and DMSF/fluorobenzene (mol) was calculated by multiplying the above two. The amount of solvent and salt remaining in the pouch was calculated as the residual amount, taking the initial amount of the solution in the pouch as 100%.

TABLE 3

| | FSI/fBz (mol) | | DMSF/fBz (mol) | |
|---|---|---|---|---|
| | Comparative | Exam- | Comparative | Exam- |
| | Example 1 | ple 1 | Example 1 | ple 1 |
| Fresh | 0.018 | 0.020 | 0.058 | 0.053 |
| 0 cycle | 0.017 | 0.018 | 0.056 | 0.050 |
| 50 cycles | 0.010 | 0.015 | 0.050 | 0.044 |
| 100 cycles | 0.007 | 0.012 | 0.044 | 0.041 |

*DMSF: N,N-dimethylsulfamoyl fluoride
FSI: bis(fluorosulfonyl)imide
fBz: fluorobenzene

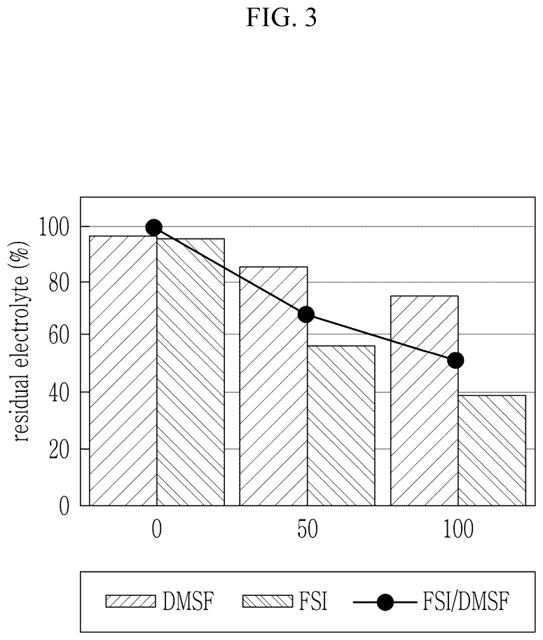

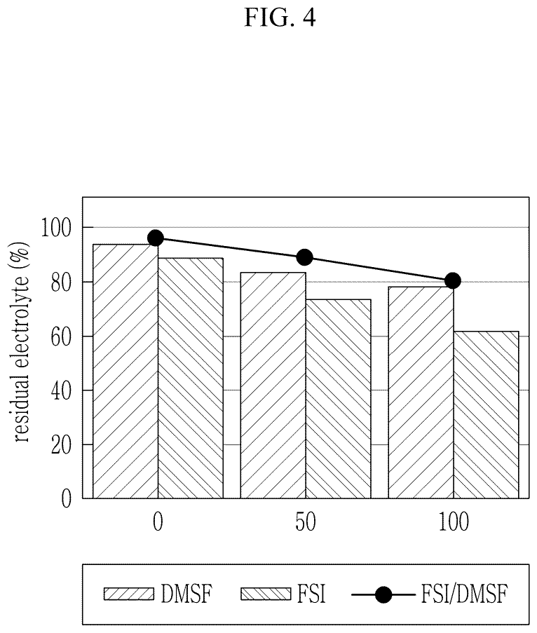

(4) By the above (3), the residual solvent and salt in the electrolyte remaining after the battery reaction can be quantified. From the above Table 3, FIGS. 3 and 4, it can be confirmed that the NMR quantitative analysis result of Comparative Example 1 exhibited a rapid decrease in the concentration of the FSI salt, which was a characteristic of the previously predicted weakly solvating solvent, and it can be seen that the main cause is the reductive decomposition of the salt. The NMR quantitative analysis results of Example 1 exhibited that the amount of FSI salt in the electrolyte remained absolutely greater than the initial amount even after 100 charge/discharge cycles. From this, it can be seen that the deterioration of the FSI salt was delayed by the introduction of the co-solvent.
(5) Finally, it can be experimentally confirmed that the durability of lithium metal battery cells can be improved by increasing the salt amount and delaying decomposition.

### Performance Verification of Lithium Metal Battery Cell Using Electrolyte Including Co-Solvent Controlling Solvation Environment-2

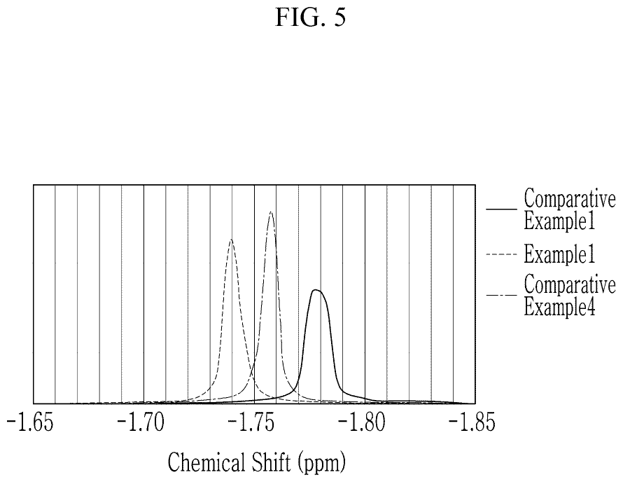

(1) In order to confirm the structure of the appropriate solvation environment of the present disclosure, Li-NMR was measured to analyze the charge state of lithium cations. In a weak solvation environment, the degree of dissociation of the salt decreases, the distance between the cation and the anion becomes closer, and electrons are donated from FSI to Li. This is because the nuclear magnetic field received by Li is blocked by the charge of Li, and the signal value is observed in the upfield.
(2) DMSF is a weak solvation electrolyte that dissociates salts to a limited extent.
(3) The ⁷Li-NMR signal value of Comparative Example 1, manufactured using DMSF as the sole solvent, was observed significantly upfield at −1.78 ppm, indicating that it was a weak solvation environment. (See FIG. 5)
(4) The charge density concentrated on FSI will decrease as much as the electrons donated from FSI to Li, and thus the oxidative decomposition of the salt can be limited to a lower energy level. However, as the charge density decreases, the approach to the negative electrode becomes easier, and a reduction reaction can occur in which additional electrons are provided from the negative electrode and decomposition occurs. This is the main cause of deterioration of the electrolyte for a lithium metal battery according to Comparative Example 1.
(5) In Example 1, it can be confirmed that the ⁷Li-NMR signal value moved downfield to −1.74 ppm. (See FIG. 5)
(6) In other words, it can be seen that the weak solvation environment is somewhat alleviated when TFEMP is used as a co-solvent in the composition of the electrolyte of Comparative Example 1, which is a weak solvation electrolyte. From this, it is thought that creating an appropriate solvation environment further enhances the inhibition of oxidative decomposition of salt.

### Amount of Co-Solvent

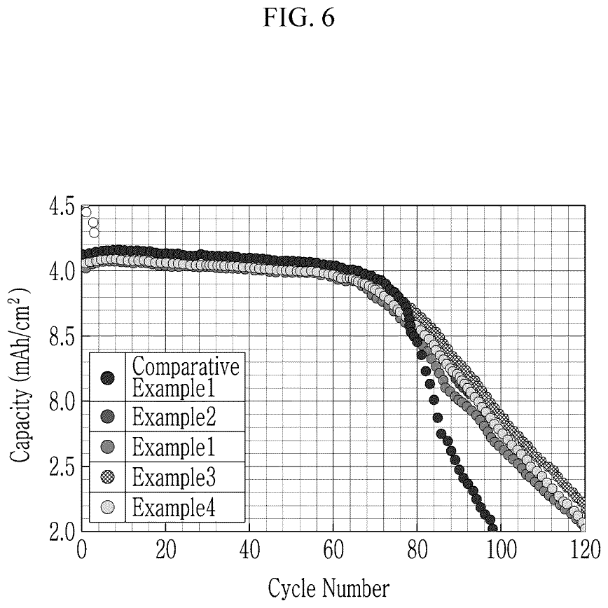

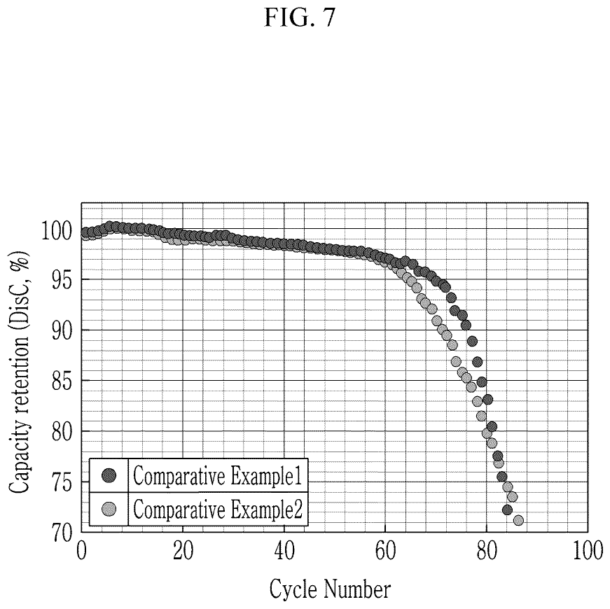

(1) Examples 1 to 4 were electrolytes with different TFEMP amounts in which durability improvement was observed, each having an amount of 2.5 mol %, 5.0 mol %, 7.5 mol %, and 10.0 mol % of the total solvent (non-aqueous organic solvent), and it can be confirmed that durability improvement effects of 5%, 4%, 10%, and 6% were observed compared to Comparative Example 1, respectively. (See FIG. 6)
(2) Comparative Example 2 is a low TFEMP amount (1.0 mol %) electrolyte, and it can be confirmed that it shows a 2% decrease in durability compared to Comparative Example 1. (See FIG. 7)
(3) The electrolyte with a high TFEMP amount (12.0 mol %) could not be evaluated due to early short circuit.
(4) Accordingly, it can be seen that the optimal amount of TFEMP based on the total amount of non-aqueous organic solvent (100 mol %) was 2.5 mol % to 10 mol %.

### Co-Solvent Structure

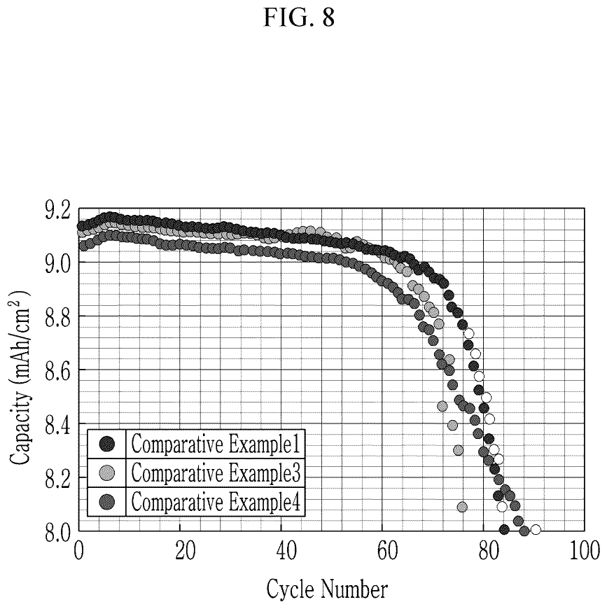

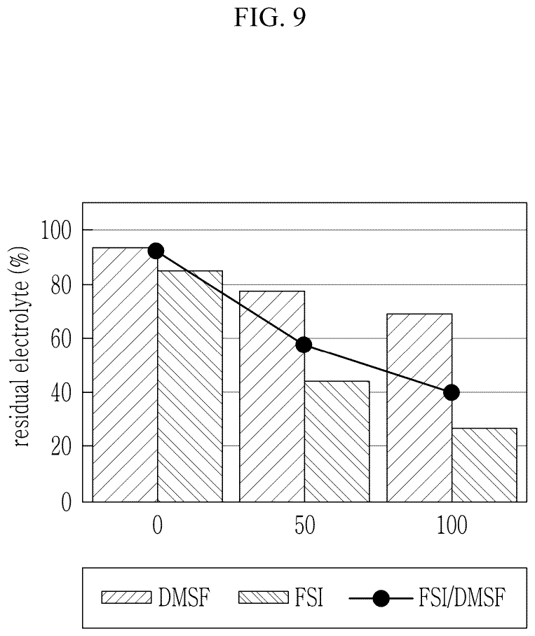

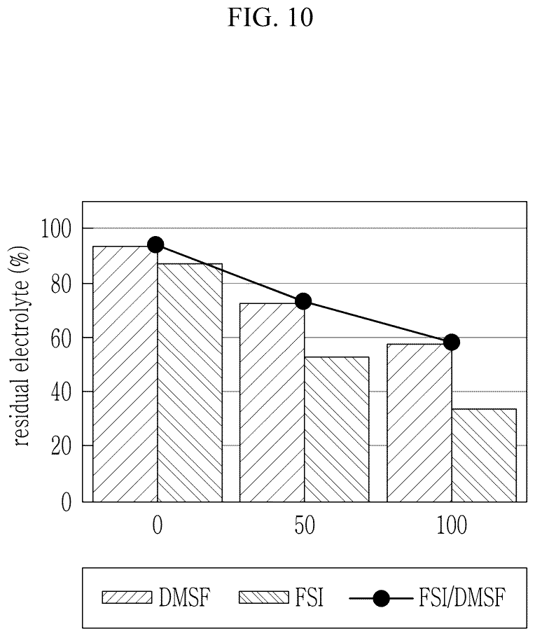

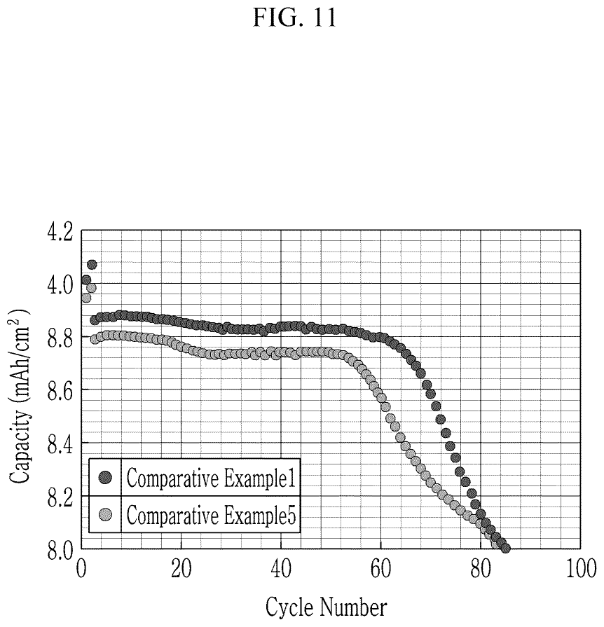

(1) Comparative Example 3 was an electrolyte prepared using DMP (1,2-dimethoxypropane) as a co-solvent. This was Comparative Example for the purpose of confirming the effect of the —CF₃ functional group by comparing the structure of the co-solvent used in Examples. When the same amount of co-solvent as Example 1 is included, the cycle-life was 74 cycles, which was terminated by 10% faster than the cycle-life (82 cycles) of Comparative Example 1 without the co-solvent (see FIG. 8). In addition, as the NMR analysis results exhibited that the FSI salt and DMSF solvent in the electrolyte of Comparative Example 3 were rapidly reduced, it can be said that the co-solvent had no effect on delaying salt decomposition (see FIG. 9). Therefore, it can be seen that the co-solvent essentially requires a —CF₃ functional group.
(2) Comparative Example 4 was an electrolyte prepared using TFDMP (1,1,1-trifluoro-2,3-dimethoxypropane) as a co-solvent, and compared to the structure of the co-solvent used in Examples, it had a symmetrical structure with methoxy groups on both sides in the structure excluding the —CF₃ functional group. It can be seen that the cycle-life ends at 81 cycles, similar to the cycle-life (82 cycles) of Comparative Example 1 that did not include a co-solvent (see FIG. 10), and also, as a result of NMR analysis, it can be observed that the FSI salt and DMSF solvent in the electrolyte of Comparative Example 4 decreased rapidly, which can be said to have no effect of delaying salt decomposition of the co-solvent. (See FIG. 10).
(3) Li-NMR of Comparative Example 4 was also observed in a downfield compared to Comparative Example 1 (−1.76 ppm), but in an upfield compared to Example 1, indicating that an optimal solvation structure is required, and TFEMP alone according to an embodiment creates that environment. (See FIG. 5) Therefore it can be seen that the ether moiety excluding the —CF₃ functional group in the co-solvent should have an asymmetric structure.
(4) Comparative Example 5 was an electrolyte prepared using TFMEP (2-Methoxy-1,1,1-trifluoro-3-ethoxypropane) as a co-solvent. Compared to the structure of the co-solvent used in Examples, it had an asymmetric structure in the opposite direction to the asymmetric structure excluding the —CF₃ functional group. In other words, TFEMP and TFMEP according to an embodiment have an asymmetric ether-based structure, but TFEMP has a —CF₃ functional group located on the ethoxy group, which is a longer aliphatic chain, and TFMEP has a structure in which —CF₃ functional group is located on the methoxy group, which is a shorter chain. When the same amount of co-solvent as in Example 1 was included, the cycle-life was 83 cycles, which was similar to the cycle-life (82 cycles) of Comparative Example 1 that did not include a co-solvent. (See FIG. 11)
(5) Therefore, it can be seen that the —CF₃ functional group in the co-solvent should be located on the longer chain (with more carbon atoms) side of the asymmetric ether-based structure.
(6) In other words, in an asymmetric structure, it can be seen that the durability improvement effect can be expected only in an electrolyte including 2.5 mol % to 10 mol % based on the total amount (100 mol %) of non-aqueous organic solvent, using a compound in which the —CF₃ functional group is located on a longer (more carbon-containing) alkoxy group as a co-solvent.

Although the example embodiments have been described above, the present disclosure is not limited thereto, and various modifications may be made within the scope of the patent claims, the detailed description of the present disclosure, and the attached drawings, which also fall within the scope of the present disclosure.

Accordingly, the substantial scope of the present disclosure is defined by the appended claims and their equivalents.

### DESCRIPTION OF SYMBOL

11 lithium metal battery
12 lithium metal layer as a negative electrode
13 positive electrode
14 separator
15 battery case

What is claimed is:

1. An electrolyte for a lithium metal battery, comprising:
a lithium salt; and
a non-aqueous organic solvent;
wherein the non-aqueous organic solvent includes a main solvent and a co-solvent,
the main solvent includes N,N-dimethylsulfamoyl fluoride, ethylene carbonate, diethyl carbonate, dimethyl carbonate, ethylmethyl carbonate, 1,2-dimethoxyether, dipropyl ether, cyclic sulfonamide, or any combination thereof,
the co-solvent is represented by Chemical Formula 1: 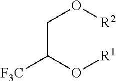
wherein, in Chemical Formula 1,
R¹ is a substituted or unsubstituted C2 to C20 alkyl group, and
R² is a substituted or unsubstituted C1 to C20 alkyl group,
wherein R¹ and R² are different from each other, and R¹ has more carbon atoms than R², and
the co-solvent is included in an amount exceeding 1 mol % based on a total amount (100 mol %) of the non-aqueous organic solvent.

2. The electrolyte of claim 1, wherein
the main solvent includes N,N-dimethylsulfamoyl fluoride.

3. The electrolyte of claim 1, wherein
R¹ is an ethyl group, and
R² is a methyl group.

4. The electrolyte of claim 1, wherein
the co-solvent is included in an amount in a range of 2.5 mol % to 10 mol % based on a total amount (100 mol %) of the non-aqueous organic solvent.

5. The electrolyte of claim 1, wherein
the lithium salt comprises at least one of lithium bis(fluorosulfonyl)imide (LiFSI), lithium (fluorosulfonyl)(nonafluorobutanesulfonyl)imide (LiFNFSI), lithium bis(trifluoromethanesulfonyl)imide (LiTFSI), or any combination thereof.

6. The electrolyte of claim 1, wherein
a concentration of the lithium salt is in a range of 1.0 M to 5.0 M.

7. The electrolyte of claim 1, wherein
a lithium nuclear magnetic resonace (Li-NMR) signal value of the electrolyte for the lithium metal battery has a more positive value than a Li-NMR signal value of an electrolyte for a lithium metal battery that does not include the co-solvent.

8. The electrolyte of claim 1, wherein the lithium salt and non-aqueous organic solvent have a molar ratio in a range of 1:1 to 1:5.

9. A lithium metal battery, comprising:
a positive electrode;
a lithium metal layer as a negative electrode facing the positive electrode;
a separator between the positive electrode and the negative electrode; and
an electrolyte,
wherein the electrolyte includes
a lithium salt, and
a non-aqueous organic solvent,
wherein:
the non-aqueous organic solvent includes a main solvent and a co-solvent,
the main solvent includes N,N-dimethylsulfamoyl fluoride, ethylene carbonate, diethyl carbonate, dimethyl carbonate, ethylmethyl carbonate, 1,2-dimethoxyether, dipropyl ether, cyclic sulfonamide, or any combination thereof,
the co-solvent is represented by Chemical Formula 1: 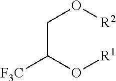
wherein, in Chemical Formula 1,
R¹ is a substituted or unsubstituted C2 to C20 alkyl group, and
R² is a substituted or unsubstituted C1 to C20 alkyl group, and
wherein R¹ and R² are different from each other, and R¹ has more carbon atoms than R², and the co-solvent is included in an amount exceeding 1 mol % based on a total amount (100 mol %) of the non-aqueous organic solvent.

10. The lithium metal battery of claim 9, wherein
the lithium metal layer is formed to have a thickness in a range of 5 μm to 50 μm.

11. The lithium metal battery of claim 9, wherein
the main solvent includes N,N-dimethylsulfamoyl fluoride.

12. The lithium metal battery of claim 9, wherein
R¹ is an ethyl group, and
R² is a methyl group.

13. The lithium metal battery of claim 9, wherein
the co-solvent is included in an amount in a range of 2.5 mol % to 10 mol % based on a total amount (100 mol %) of the non-aqueous organic solvent.

14. The lithium metal battery of claim 9, wherein
the lithium salt comprises at least one of lithium bis(fluorosulfonyl)imide (LiFSI), lithium (fluorosulfonyl)(nonafluorobutanesulfonyl)imide (LiFNFSI), lithium bis(trifluoromethanesulfonyl)imide (LiTFSI), or any combination thereof.

15. The lithium metal battery of claim 9, wherein
a concentration of the lithium salt is in a range of 1.0 M to 5.0 M.

16. The lithium metal battery of claim 9, wherein
a lithium nuclear magnetic resonace (Li-NMR) signal value of the electrolyte for the lithium metal battery has a more positive value than a Li-NMR signal value of an electrolyte for a lithium metal battery that does not include the co-solvent.

17. The lithium metal battery of claim 9, wherein the lithium salt and non-aqueous organic solvent have a molar ratio in a range of 1:1 to 1:5.

18. A lithium metal battery, comprising:
a first electrode;
a lithium metal layer as a second electrode facing the first electrode;
a separator between the first electrode and the second electrode; and
an electrolyte,
wherein the electrolyte includes:
a lithium salt, and
a non-aqueous organic solvent,
wherein:
the non-aqueous organic solvent includes a main solvent and a co-solvent,
the main solvent includes N,N-dimethylsulfamoyl fluoride, ethylene carbonate, diethyl carbonate, dimethyl carbonate, ethylmethyl carbonate, 1,2-dimethoxyether, dipropyl ether, cyclic sulfonamide, or any combination thereof,
the co-solvent is represented by Chemical Formula 1: 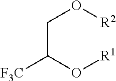
wherein, in Chemical Formula 1,
R¹ is a substituted or unsubstituted C2 to C20 alkyl group, and
R² is a substituted or unsubstituted C1 to C20 alkyl group, and
wherein R¹ and R² are different from each other, and R¹ has more carbon atoms than R², and the co-solvent is included in an amount exceeding 1 mol % based on a total amount (100 mol %) of the non-aqueous organic solvent.

19. The electrolyte of claim 18, wherein
the main solvent includes N,N-dimethylsulfamoyl fluoride.

20. The electrolyte of claim 18, wherein
the lithium salt comprises at least one of lithium bis(fluorosulfonyl)imide (LiFSI), lithium (fluorosulfonyl)(nonafluorobutanesulfonyl)imide (LiFNFSI), lithium bis(trifluoromethanesulfonyl)imide (LiTFSI), or any combination thereof.
